(19) United States
(12) Patent Application Publication
(10) Pub. No.: US 2010/0031832 A1
(43) Pub. Date: Feb. 11, 2010

(54) Can presser

(75) Inventor: Simon Huang, SanChung City (TW)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd., SanChung City (TW)

(21) Appl. No.: 12/222,252

(22) Filed: Aug. 6, 2008

(51) Int. Cl. B30B 9/32

(52) U.S. Cl. 100/98 R

(57) ABSTRACT

The disclosed can presser has a movable pressing board between the front and back fixing boards of a frame. It further has a driving component to make the movable pressing board perform a reciprocal displacement between the front and back fixing boards. The can presser uses the space between the front fixing board of the frame and the moving pressing board as the empty can storage space. As the moving pressing board displaces toward the front fixing board to a stop point, the empty can is gradually squeezed to reduce its size. Finally, the driving component brings the movable pressing board backward toward the back fixing board for the squeezed empty can to be taken out.

### BACKGROUND OF THE INVENTION

1. Field of Invention

The invention relates to a can presser and, in particular, to a can presser structure that presses an empty can to reduce its storage space.

2. Related Art

The purpose of resource recycling is to recycle certain trashes after classification and to reuse them. After continual propaganda, the concept of classifying and recycling trashes has, been established among citizens. The amount of trashes has largely reduced.

Among recycled trashes, empty cans made of iron and aluminum usually occupy a lot of space because of their sizable volumes. This is particularly inconvenient in transportation. Therefore, people often step empty cans flat to reduce the space occupied by them. However, such flattened empty cans do not have a uniform shape. Moreover, people may get hurt when stepping them flat.

### SUMMARY OF THE INVENTION

In view of the foregoing, an objective of the invention is to provide a can presser that presses an empty can to reduce its size.

To achieve the above-mentioned objective, the disclosed can presser has a frame, a movable pressing board, and a driving component. The frame has a front fixing board, a back fixing board, and several guiding posts extended and disposed between the front and back fixing boards. The movable pressing board is disposed between the front and back fixing boards of the frame via the guiding posts. The driving component drives the movable pressing board to perform a reciprocal displacement between the front and back fixing boards.

When the movable pressing board moves toward the back fixing board and reaches a back stop point, the space between the front fixing board of the frame and the movable pressing board accommodates an empty can. As the movable pressing board moves toward the front fixing board to a front stop point, the empty can is gradually squeezed to reduce its volume. After the movable pressing board reaches the front stop point, the driving component drives the movable pressing board to move toward the back fixing board. Afterwards, the squeezed empty can is taken out.

### BRIEF DESCRIPTION OF THE DRAWINGS

The invention will become more fully understood from the detailed description given herein below illustration only, and thus is not limitative of the present invention, and wherein:

FIG. 1 is a front structural view of the can presser according to the first embodiment of the invention;

FIG. 2 is a top structural view of the can presser according to the first embodiment of the invention;

FIG. 3 schematically shows that the empty can is squeezed in one way;

FIG. 4 schematically shows that the empty can is squeezed in another way;

FIG. 5 is a front structural view of the can presser according to the second embodiment of the invention;

FIG. 6 is a side view of the second embodiment when the flip cover is opened; and

FIG. 7 is a side view of the second embodiment when the flip cover is closed.

### DETAILED DESCRIPTION OF THE INVENTION

The present invention will be apparent from the following detailed description, which proceeds with reference to the accompanying drawings, wherein the same references relate to the same elements.

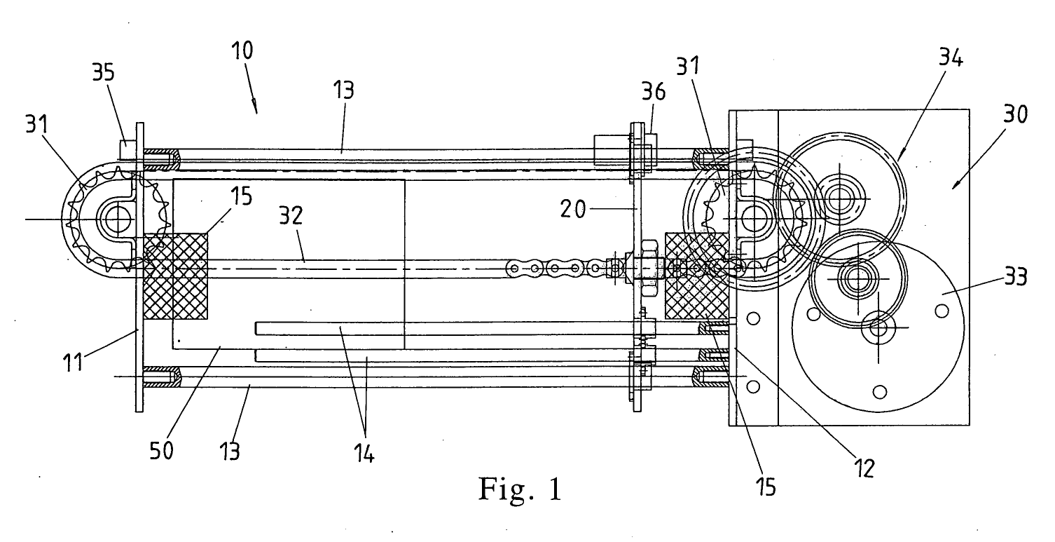

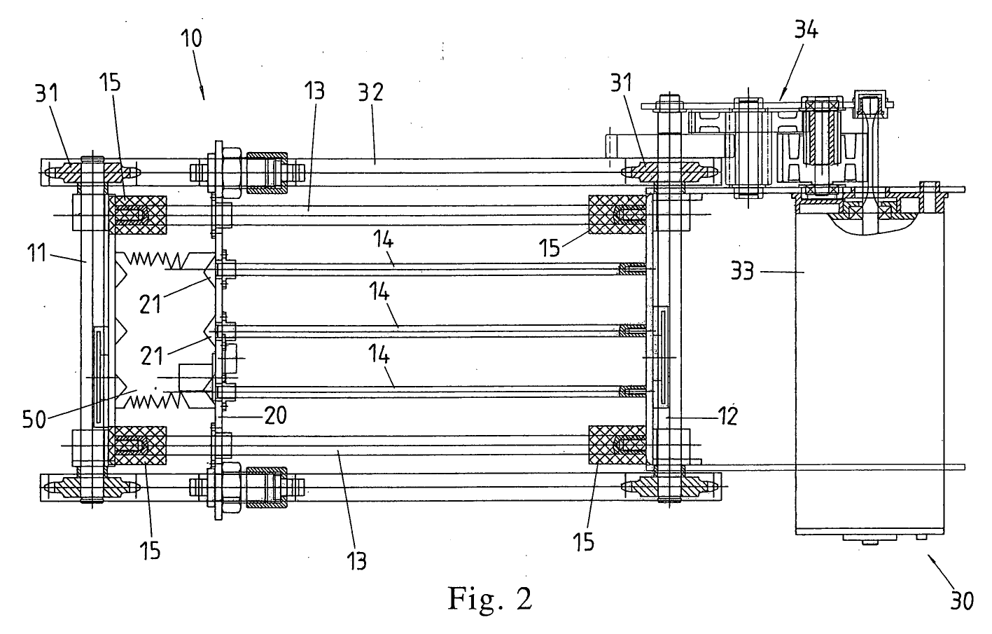

As shown in FIG. 1, a front structural view according to a first embodiment, and FIG. 2, a top structural view of the first embodiment, the disclosed can presser mainly includes: a frame 10, a movable pressing board 20, and a driving component 30.

The frame 10 has a front fixing board 11 and a back fixing board 12. Besides, several guiding posts 13 extend between the front and back fixing boards 11, 12. In practice, the frame 10 further has several supporting rods 14 on the back fixing board 12 extending toward the front fixing board 11 to support an empty can 50. Each supporting rod 14 preferably keeps a distance from the front fixing board 11, so that the squeezed empty can 50 can fall through the space between the supporting rods 14 and the front fixing board 11.

The movable pressing board 20 is disposed between the front and back fixing boards 11, 12 of the frame 10 using the guiding posts 13. Several conic protrusions 21 are formed on the surface of the movable pressing board 20 that faces the front fixing board 11 for piercing the empty can 50.

The driving component 30 makes the movable pressing board 20 perform a reciprocal displacement between the front and back fixing boards 11, 12 along the guiding posts 13. In practice, the driving component 30 has chain gears 31 at the front and back fixing boards 11, 12 of the frame 10, respectively. A chain 32 connected with the movable pressing board 20 winds around the two chain gears 31. A motor 33 and a speed reducing gear set 34 are provided to rotate the chain gears forward and backward, achieving the goal of making the movable pressing board 20 perform the reciprocal displacement between the front and back fixing boards 11, 12 along the guiding posts 13.

Furthermore, the driving component 30 has a front magnetic switch 35 and a back magnetic switch 36 on both ends of the guiding posts 13 near the front and back fixing boards 11, 12. The front and back magnetic switches 35, 36 act under the influence of a magnet on the movable pressing board 20 as it approaches them. They control the driving component 30 so that the movable pressing board 20 stops at those positions. By changing the positions of the front and back magnetic switches 35, 36, one can adjust the front and back stop points of the movable pressing board 20.

When the movable pressing board 20 moves toward the back fixing board 12 to the back stop point, the space between the front fixing board 11 of the frame 10 and the movable pressing board 20 accommodates the empty can 50. As the movable pressing board 20 moves toward the front fixing board 11 to reach the front stop point, the empty can 50 is gradually squeezed to reduce its size. After the movable pressing board 20 moves toward the front fixing board and reaches the front stop point, the driving component 30 brings the movable pressing board 20 backward toward the back fixing board 12. The squeezed empty can is then taken out.

In addition to the front and back stop points, the disclosed can presser has a plurality of buffer pads 15 on the surfaces of the front and back fixing boards 11, 12 that face the movable pressing board 20. They prevent the movable pressing board 20 from colliding with the front and back fixing boards 11, 12.

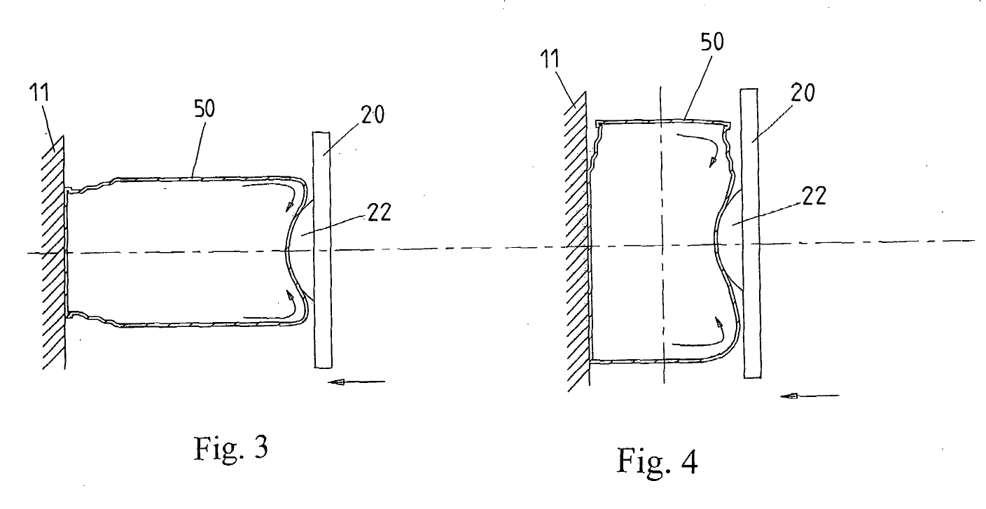

Moreover, the movable pressing board 20 further has a ball protrusion 22 on the surface facing the front fixing board 11 in addition to the conic protrusions 21, as shown in FIGS. 3 and 4. As the movable pressing board 20 presses the empty can 50, the cross-sectional material of the empty can 50 first moves in the arrow direction due to the pressure from the ball protrusion 22. This reduces the reaction of the can on the movable pressing board, thereby reducing the required force.

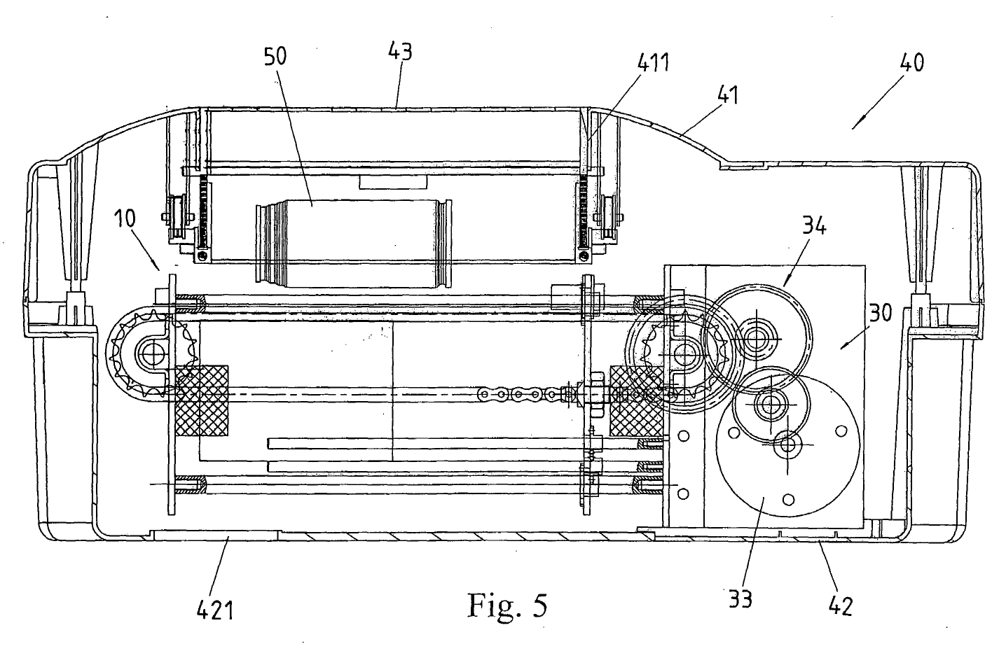

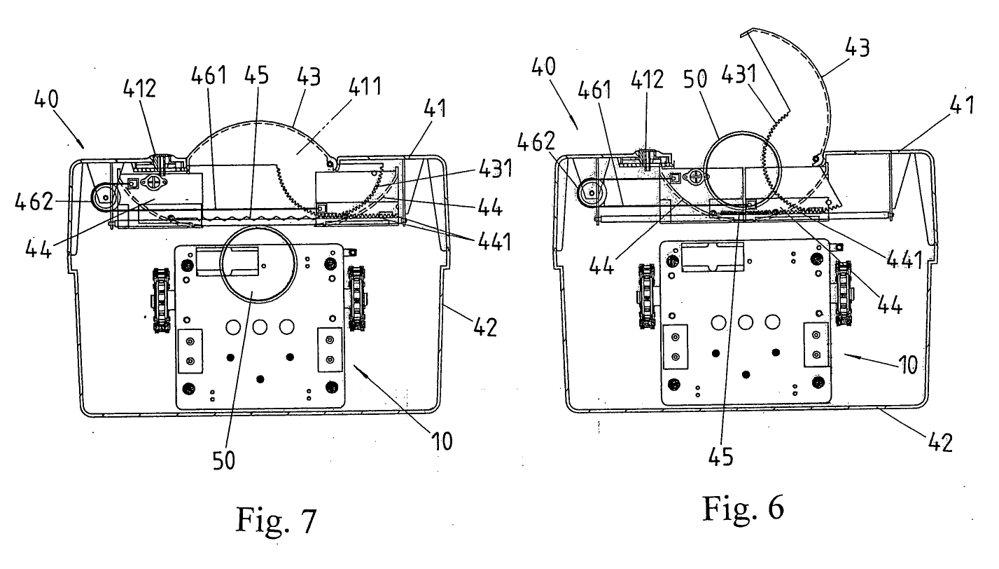

Please refer to FIGS. 5 and 6. In practice, the frame 10, the movable pressing board 20, and the driving component 30 of the can presser are covered by a case 40. The case 40 has an upper shell 41, a lower shell 42, and a flip cover 43.

The upper shell 41 has an opening 411 for the insertion of the empty can 50. The lower shell 42 has an exit opening 421 for the empty can 50 to exit. The flip cover 43 is provided at the opening 411 on the upper shell 41, covering the opening 411. A button 412 that determines whether the flip cover 43 can be opened is provided on the upper shell 41.

Besides, two sliding bases 44 connecting with the flip cover 43 are provided in the case 40 correspondingly below the opening 411 of the upper shell 41. More explicitly, the two sliding bases 44 are provided on both sides below the opening 411 of the upper shell 41 and connected by a spring 45. The sliding base 44 closer to the axis of the flip cover 43 is provided with a saw bar 441. The flip cover 43 has a corresponding semi-circular gear 431 extending to the inner side of the upper shell 41 matching with the saw bar 441 of the sliding base 44. A cable 461 goes around a pulley 462 to form the semi-circular gear 441 and connects with the other sliding base 44.

Therefore, when the user presses the button 412 to open the flip cover 43, the sliding base 44 matching with the flip cover 43 is displaced toward the center of the opening 411 by the pulling force of the spring 45. At the same time, the flip cover 43 opens up. In the meantime, the cable 461 is concurrently released so that the other sliding base 44 is also pulled toward the center of the opening 411 by the spring 45. In other words, as the flip cover 43 opens up, the two sliding bases 44 simultaneously enter the region right below the opening 411. In addition to receiving the empty can 50, they also separate the parts inside the case 40 from the exterior. This increase the safety of the invention.

When the flip cover 43 closes, as shown in FIG. 7, the two sliding bases 44 backed out of the region under the opening 411 under the influence of the semi-circular gear 431 and the cable 461. The originally supported empty 50 thus falls in the region between the movable pressing board and the front fixing board for pressing.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A can presser, comprising:
a frame, which has a front fixing board, a back fixing board, and a plurality of guiding posts extended between the front and back fixing boards;
a movable pressing board, which is disposed between the front and back fixing boards using the guiding posts; and
a driving component, which drives the movable pressing board to perform a reciprocal displacement between the front and back fixing boards.

2. The can presser of claim 1, wherein the frame has a plurality of supporting rods extending from the back fixing board toward the front fixing board for supporting the empty can.

3. The can presser of claim 2, wherein each of the supporting rods preferably keeps a distance from the front fixing board for the squeezed empty can to fall through the space between the supporting rods and the front fixing board.

4. The can presser of claim 1, wherein the movable pressing board has a plurality of conic protrusions on its surface that faces the front fixing board for piercing the empty can.

5. The can presser of claim 1, wherein the driving component has chain gears at the front and back fixing boards of the frame, a chain connected with the movable pressing board winds around the chain gears, and a motor and a speed varying gear set are used to rotate the chain gears forward and backward.

6. The can presser of claim 1, wherein the driving component has a front magnetic switch and a back magnetic switch on both ends of the guiding posts near the front and back fixing boards, respectively so that the front and back magnetic switches are attracted by magnets on the movable pressing board as it approaches, thereby controlling the driving component to stop the movable pressing board at the corresponding position.

7. The can presser of claim 1, wherein the surface of the movable pressing board facing the front fixing board has a ball protrusion.

8. The can presser of claim 4, wherein the surface of the movable pressing board facing the front fixing board has a ball protrusion.

9. The can presser of claim 1, wherein the surfaces of the front and back fixing boards facing the movable pressing board have a plurality of buffer pads.

10. The can presser of claim 1, wherein the frame, the movable pressing board, and the driving component are covered by a case.

11. The can presser of claim 10, wherein the case includes:
an upper shell, which has an opening for the insertion of the empty can;
a lower shell, which has an exit opening for the empty can to leave; and
a flip cover, which is provided in the vicinity of the opening on the upper shell for covering it.

12. The can presser of claim 11 further comprising two sliding bases connecting with the flip cover and below the opening of the upper shell; wherein the sliding bases are provided on both sides below the opening of the upper shell and connected via a spring, one of the sliding bases closer to the axis of the flip cover is provided with a saw bar, the flip cover has a corresponding semi-circular gear extending t the inner side of the upper shell to match with the saw bar, and a cable goes through a pulley to form the semi-circular gear and connects with the other sliding base.

13. The can presser of claim 11, wherein a button determining whether the flip cover opens is provided on the upper shell.

14. The can presser of claim 12, wherein a button determining whether the flip cover opens is provided on the upper shell.
